(19) United States
(12) Patent Application Publication
(10) Pub. No.: US 2010/0060865 A1
(43) Pub. Date: Mar. 11, 2010

(54) ELECTRONIC DEVICE WITH OPENING/CLOSING DOOR

(75) Inventors: Yosuke Nishihata, Osaka (JP); Koichi Tsutsumi, Osaka (JP); Takeshi Fujisaki, Amagasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/556,124

(22) Filed: Sep. 9, 2009

(30) Foreign Application Priority Data
Sep. 10, 2008 (JP) 2008-231589

(51) Int. Cl. G03B 21/14

(52) U.S. Cl. 353/91

(57) ABSTRACT

An electronic device with an opening/closing door of the present invention includes a device body in which an opening is defined, a shutter system capable of covering and exposing the opening, and a loosely fixing mechanism. The shutter system includes a door capable of moving back and forth between a closed position for covering the opening and an open position for exposing the opening, an arm swingably supported by the device body and having a front end engaging with the door, a motor for opening and closing the door by driving the arm, and a controller for controlling the operation of the motor. The controller is capable of switching the function of the motor between an electric motor and an electric generator. The loosely fixing mechanism is linked to the arm of the shutter system, and loosely fixes the arm when the door is placed at the open position, while loosely fixing the arm when the door is placed at the closed position. The controller causes the motor to function as an electric motor in the process of opening and closing the door, while causing the motor to function as an electric generator when the door is loosely fixed at the open position or at the closed position.

The Japanese application Number 2008-231589, upon which this patent application is based, is hereby incorporated by reference.

### BACKGROUND OF THE INVENTION

1. Field of the Invention

The present invention relates to an electronic device with an opening/closing door such as an LCD projector including a shutter system.

2. Description of Related Art

In an LCD projector for projecting images onto a screen, there has been a need for temporarily suspending image projection onto the screen while causing a light source for the image projection to stay on. By way of example, in a conventionally used LCD projector, a shutter system constituted by a plurality of shutters is arranged between an optical device with a color synthesizing prism and the like and a light source. The shutter system is closed by rotating the plurality of shutters, thereby temporarily interrupting the passage of light.

The conventionally used LCD projector requires the complicated structure of the shutter system due to the need for rotating the plurality of shutters. In response, a shutter system 100 shown in FIG. 18 has been proposed. The shutter system 100 includes a pair of doors 101 and 102 for interrupting light that respectively move up and down. More specifically, in addition to the pair of doors 101 and 102, the shutter system 100 includes a motor 103, an arm 104, a gear 105 for transmitting the rotation of the motor 103 to the arm 104, and a mounting table 106 for holding these parts thereon. An opening 107 through which light passes is defined in the mounting table 106.

The doors 101 and 102 in a pair are arranged above and below the opening 107 respectively, and can slide along a surface of the mounting table 106. More specifically, the doors 101 and 102 in a pair are fixed to sliding plates 108 and 109 respectively that are slidably arranged on opposite sides of the opening 107. When the sliding plates 108 and 109 slide up and down, the doors 101 and 102 in a pair also move (slide) up and down.

The arm 104 is rotatably supported on the mounting table 106. More specifically, the arm 104 is supported at a central part 110 on the mounting table 106. Further, the arm 104 is so arranged that a pivot point 111 of the arm 104 is placed on a center line 119 of the width of the doors 101 and 102. Thus, opposite ends 112 and 113 of the arm 104 are allowed to move about the pivot point 111. More specifically, while the end 112 (113) moves up about the pivot point 111, the end 113 (112) moves down about the pivot point 111. The arm 104 is caused to pivot by transmitting the rotation of the motor 103 through the gear 105 to the arm 104.

The opposite ends 112 and 113 of the arm 104 respectively engage with the sliding plates 108 and 109 in a pair. By fitting projections 121 and 122 provided to the shutter system 100 into holes 123 and 124 defined in the sliding plates 108 and 109 respectively, the sliding plates 108 and 109 are guided so as to move straight up and down. So, the pivotal movement of the arm 104 about the pivot point 111 causes the sliding plate 108 engaging with the end 112 of the arm 104 to slide down, while causing the sliding plate 109 engaging with the end 113 of the arm 104 to slide up. Thus, the door 101 moves down while the door 102 moves up. As a result, the opening 107 is covered with the pair of doors 101 and 102, thereby interrupting light from the light source.

When the arm 104 is caused by the motor 103 to pivot about the pivot point 111 in the opposite direction, the sliding plate 108 engaging with the end 112 of the arm 104 slides up, and the sliding plate 109 engaging with the end 113 of the arm 104 slides down as shown in FIG. 18. Thus, the door 101 moves up while the door 102 moves down. As a result, the opening 107 is exposed so that light from the light source is allowed to pass through the opening 107.

The shutter system 100 including only the pair of doors 101 and 102 has a complicated structure, and a high degree of accuracy is required to smoothly open and close the doors 101 and 102, resulting in high cost of manufacturing the shutter system 100. Further, the pair of doors 101 and 102, and the arm 104 are held on the same surface of the mounting table 106 in the shutter system 100. So, the pair of doors 101 and 102, and the arm 104 should be arranged in a manner that avoids the interference therebetween, resulting in the upsizing of the shutter system 100.

A structure described next may be effective in downsizing a shutter system. Namely, this shutter system includes a single door, and only the end 112 of the arm 104 engages with this door while the end 113 is pivotably supported on the mounting table 106. However, the door engages with only one end of the arm in this structure. So, high torque is likely to be generated at one end of the arm engaging with the door by the application of external force. As a result, the door may be opened or closed contrary to an operator's intention.

### SUMMARY OF THE INVENTION

It is an object of the present invention to provide an electronic device with an opening/closing door including a shutter system capable of preventing the opening and closing of a door contrary to an operator's intention caused by the application of external force.

An electronic device with an opening/closing door of a first aspect of the present invention includes a device body in which an opening is defined, a shutter system capable of covering and exposing the opening, and a loosely fixing mechanism. The shutter system includes a door capable of moving back and forth between a closed position for covering the opening and an open position for exposing the opening, an arm swingably supported by the device body and having a front end engaging with the door, a motor for opening and closing the door by driving the arm, and a controller for controlling the operation of the motor. The controller is capable of switching the function of the motor between an electric motor and an electric generator. The loosely fixing mechanism is linked to the arm of the shutter system, and loosely fixes the arm when the door is placed at the open position, while loosely fixing the arm when the door is placed at the closed position. The controller causes the motor to function as an electric motor in the process of opening and closing the door, while causing the motor to function as an electric generator when the door is loosely fixed at the open position or at the closed position.

According to the electronic device with an opening/closing door of the first aspect, the loosely fixing mechanism loosely fixes the arm when the door is placed at the open position. Thus, the door tries to stay at the open position even when external force is applied in a direction in which the door is closed. Likewise, the loosely fixing mechanism loosely fixes the arm when the door is placed at the closed position. Thus, the door tries to stay at the closed position even when external force is applied in a direction in which the door is opened. Further, the motor is caused to function as an electric generator when the door is loosely fixed at the open or closed position. As a result, the motor prevents the movement of the door from the state in which the door is loosely fixed at the open or closed position (brake-mode control). Thus, the door does not easily deviate from the open or closed position contrary to an operator's intention.

According to a second aspect of the electronic device with an opening/closing door of the present invention, in the electronic device with an opening/closing door of the first aspect, the loosely fixing mechanism includes a part capable of moving in the axial direction of a support shaft of the arm while being prevented from rotating about the axis of the support shaft, a spring member for biasing the part toward the arm, a projection projecting from the part or the arm, and depressions in a pair defined in the part or the arm to which the projection is not provided. One of the depressions in a pair loosely fixes the projection when the door is placed at the open position. The other one of the depressions in a pair loosely fixes the projection when the door is placed at the closed position.

According to a third aspect of the electronic device with an opening/closing door of the present invention, in the electronic device with an opening/closing door of the first or second aspect, the controller includes a detection part and a return part. The detection part is configured to detect the deviation of the door from the open position or from the closed position when the door should be held at the open position or at the closed position. The return part is configured to cause the door to return to its original position by causing the motor to function as an electric motor when the detection part detects deviation.

According to the electronic device with an opening/closing door of the third aspect, even when external force is applied to release the door from its loosely fixed state in opposition to the fixing force of the loosely fixing mechanism and the force of the motor to prevent the movement of the door so that the door deviates from the open or closed position, the door returns to its original position and is held at the open or closed position again.

According to a fourth aspect of the electronic device with an opening/closing door of the present invention, in the electronic device with an opening/closing door of the third aspect, the detection part includes a first limit switch and a second limit switch. The first limit switch is switched from OFF to ON when the door reaches the open position. The second limit switch is switched from OFF to ON when the door reaches the closed position. The detection part detects the deviation of the door from the open position or from the closed position by detecting the switching of the first limit switch or the second limit switch from ON to OFF when the door should be held at the open position or at the closed position.

According to a fifth aspect of the electronic device with an opening/closing door of the present invention, in the electronic device with an opening/closing door of any one of first to fourth aspects, the shutter system further includes a mounting table having a front surface and a rear surface. The arm and the motor are arranged on the front surface, and the door is arranged on the rear surface. The door is capable of sliding along the rear surface of the mounting table. The arm is so arranged as to overlap the door placed at the open position or at the closed position. The arm has a root end and the front end. The root end is pivotably supported on the front surface of the mounting table at a position closer to one side edge portion of the door than a center line of the width of the door. The front end engages with the other side edge portion of the door without holding the mounting table therebetween. The motor causes the arm to swing about the root end as a pivot point, thereby causing the door to slide along the rear surface of the mounting table.

According to the electronic device with an opening/closing door of the fifth aspect, the distance from the root end (pivot point) to the front end (point of effort) of the arm engaging with the door is greater than half the width of the shutter system. So, compared to a conventionally used shutter system in which the length of an arm from a pivot point to either end is half the width of the conventionally used shutter system, a ratio of the length of the arm to the width of the shutter system is high. The length of the arm can even be the same as the width of the shutter system according to the position of the pivot point of the arm. Thus, a stroke of the front end of the arm is longer than that in the conventionally used shutter system with the same angle of rotation. As a result, the door moves a longer distance in a sliding direction than in the conventionally used shutter system. So, the opening can be covered and exposed by the single door. Further, the simple structure allows the door to be smoothly opened and closed.

The electronic device with an opening/closing door described above includes the single door. So, the door has a weight greater than that of one of the doors moving in opposite directions in the conventionally used shutter system. Further, the arm has a length greater than that of the arm in the conventionally used shutter system. Still further, the door engages with only one end (front end) of the arm. So, high torque is likely to be generated at the front end of the arm by the application of external force. However, the above-described electronic device with an opening/closing door can hold the door at the closed or open position even when external force is applied to the door.

As described above, the electronic device with an opening/closing device of the present invention is capable of preventing the opening and closing of the door in the shutter system contrary to an operator's intention that is caused by the application of external force.

### BRIEF DESCRIPTION OF THE DRAWINGS

FIG. 1 is a perspective view of an LCD projector according to a preferred embodiment of the present invention;

FIG. 2 is a perspective view of the LCD projector when viewed from its front side with a cover detached from the LCD projector;

FIG. 3 is a perspective view of the LCD projector when viewed from its rear side with the cover detached from the LCD projector;

FIG. 4 is a perspective view of an optical device when viewed from its front side;

FIG. 5 is a perspective view of the optical device when viewed from its rear side;

FIG. 6 is a plan view of the optical device;

FIG. 7 is a perspective view of a shutter system with an opening closed when viewed from the front surface side of a mounting table;

FIG. 8 is a perspective view of the shutter system with the opening closed when viewed from the rear surface side of the mounting table;

FIG. 9 is an exploded perspective view of the shutter system with the opening closed;

FIG. 10 is a perspective view of the shutter system with the opening open when viewed from the front surface side of the mounting table;

FIG. 11 is an exploded perspective view of the shutter system with the opening open;

FIG. 12 is an exploded perspective view of a loosely fixing mechanism when a door is placed at an open position;

FIG. 13 is a perspective view of a click plate;

FIG. 14 is an exploded perspective view of the loosely fixing mechanism when the door is placed at a closed position;

FIG. 15 is a block diagram explaining the control of the shutter system when the door is placed at the open position;

FIG. 16 is a block diagram explaining the control of the shutter system when the door is placed at the closed position;

FIG. 17 is a flow diagram explaining the control of the shutter system; and

FIG. 18 is an exploded perspective view of a conventionally used shutter system.

### DETAILED DESCRIPTION OF THE EMBODIMENTS

A preferred embodiment of the present invention is described in detail below with reference to drawings when the present invention is implemented in an LCD projector.

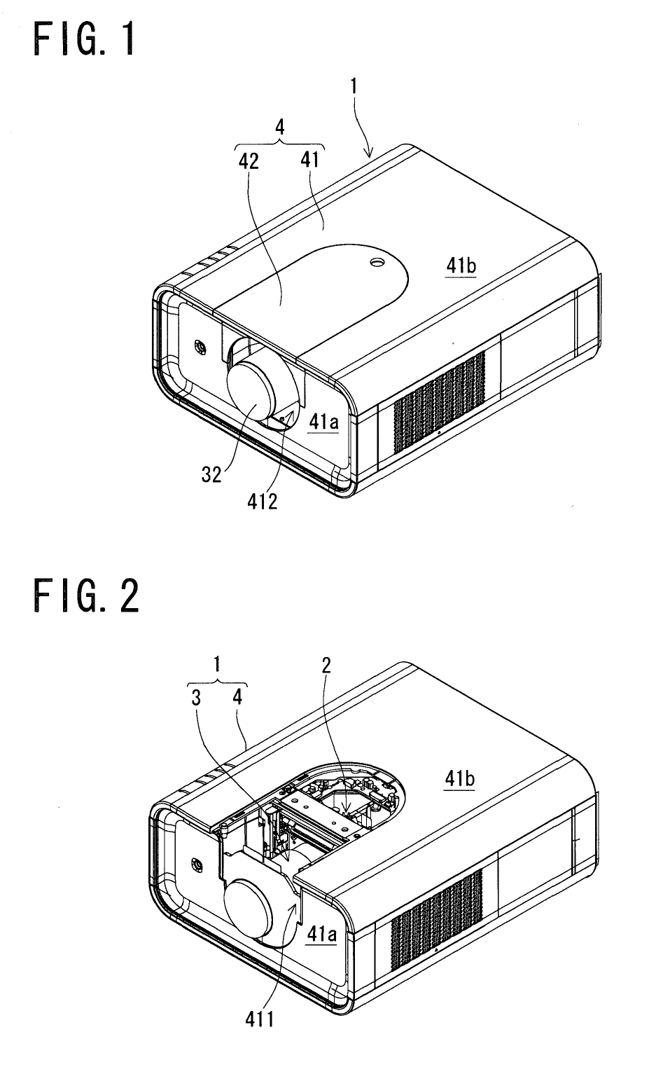

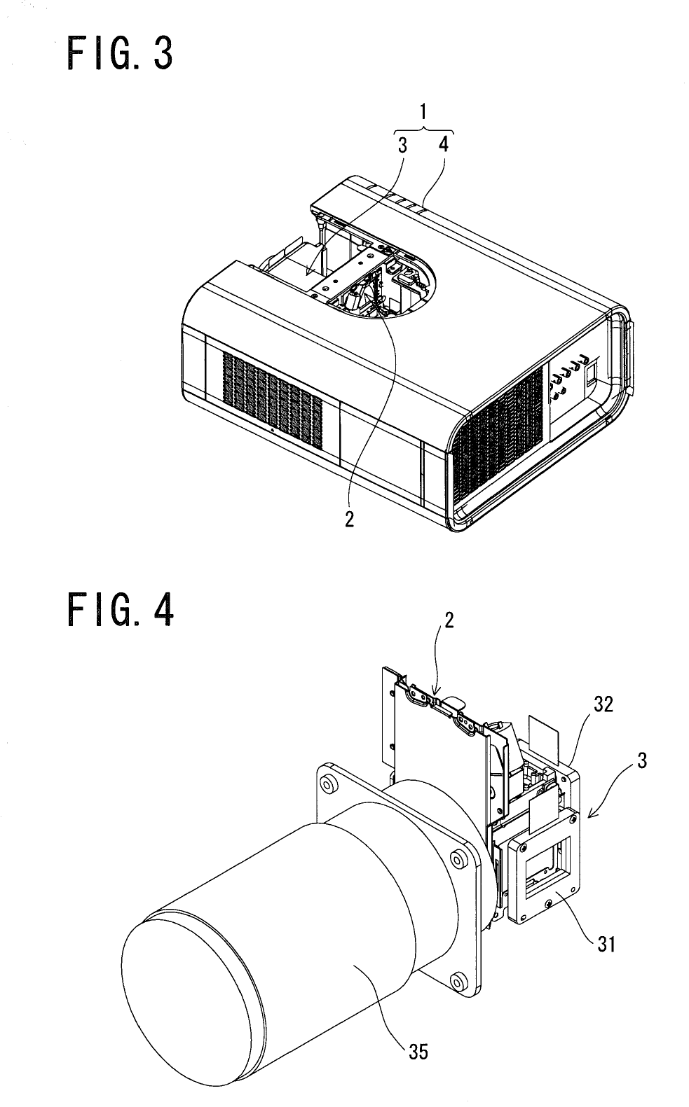

An LCD projector according to the preferred embodiment of the present invention is substantially a flattened rectangular parallelepiped in outer appearance as shown in FIG. 1, and includes a device body 1 and a shutter system 2 as shown in FIGS. 2 and 3.

As shown in FIGS. 2 and 3, the device body 1 is constituted by an optical device 3 for generating color images, and a case 4 for storing therein the optical device 3. Although not shown, a light source, and a spectroscope for dividing white light emitted from the light source into three primary colors (red color, green color, blue color) is provided inside the case 4.

As shown in FIG. 1, the case 4 is constituted by a case body 41 and a cover 42. A through hole 411 is so defined in the case body 41 as to extend from a front surface 41a to an upper surface 41b of the case body 41 as shown in FIG. 2. The cover 42 is attached to and detached from the case body 41. When the cover 42 is attached to the case body 41 (FIG. 1), with part 412 of the through hole 411 existing at the front surface 41a remaining exposed in the shape of a circle, the cover 42 covers the remaining part of the through hole 411. The part of the through hole 411 covered with the cover 42 is defined in a manner that allows an operator to reach the shutter system 2 described later by inserting a hand into the case body 41 through this part of the through hole 411.

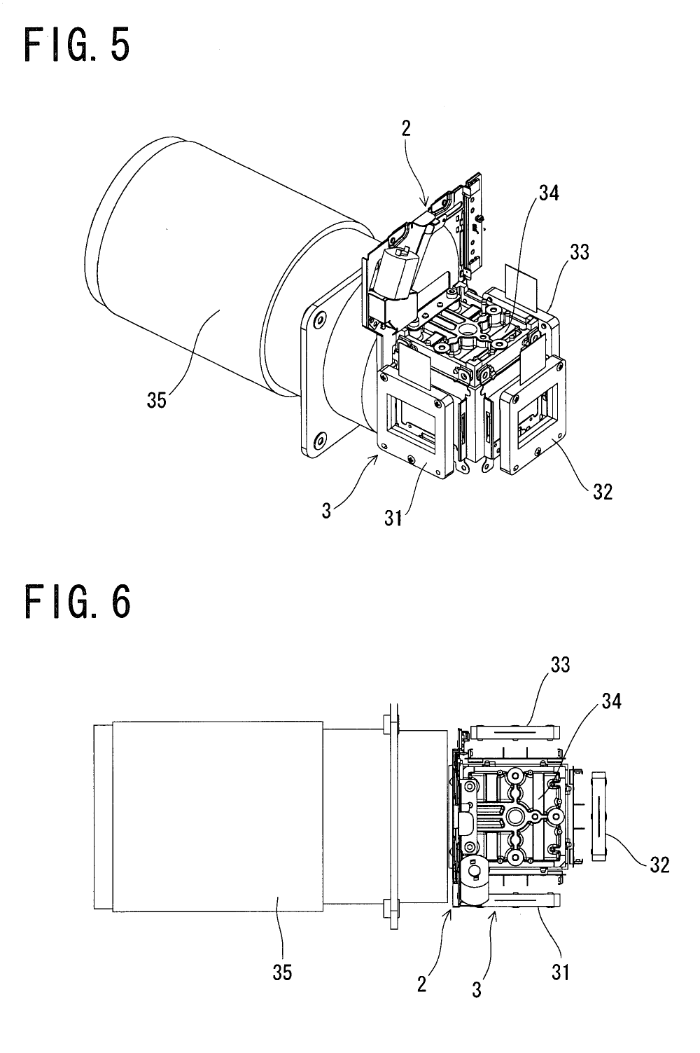

As shown in FIGS. 4 to 6, the optical device 3 includes a red image generation part 31, a green image generation part 32, a blue image generation part 33, a color synthesizing prism 34, and a projection lens 35. The optical device 3 generates a color image using three primary colors obtained by the above-described spectroscope.

More specifically, the red image generation part 31, the green image generation part 32, and the blue image generation part 33 each have an LCD panel therein. The red image generation part 31 generates a portion of a color image relating to red color (red image) using red light emitted from the spectroscope. The green image generation part 32 generates a portion of the color image relating to green color (green image) using green light emitted from the spectroscope. The blue image generation part 33 generates a portion of the color image relating to blue color (blue image) using blue light emitted from the spectroscope. The images generated by the red image generation part 31, the green image generation part 32 and the blue image generation part 33 enter the color synthesizing prism 34.

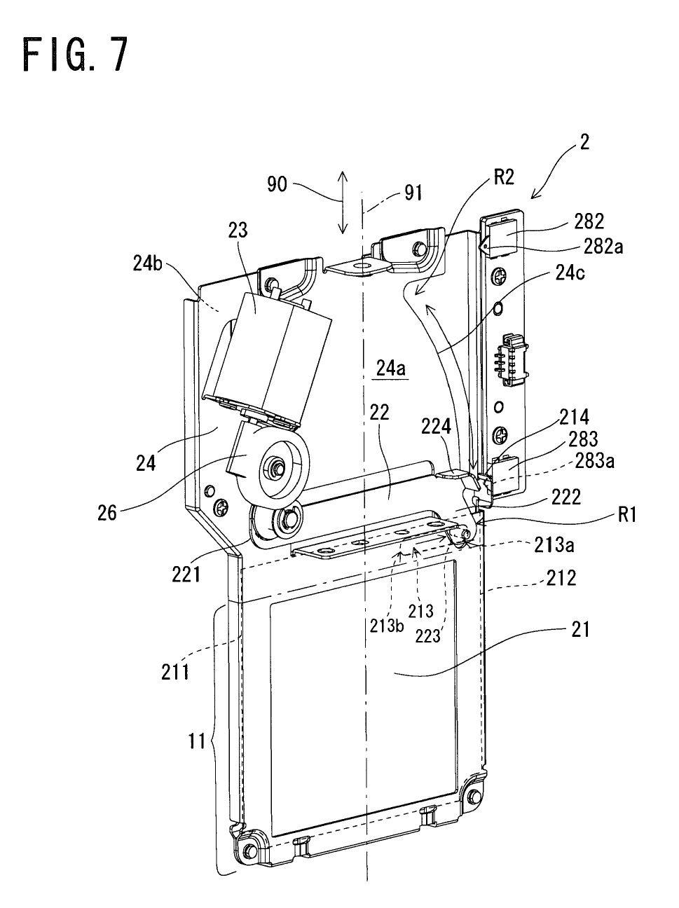

The color synthesizing prism 34 synthesizes the received images of the three colors to generate one color image. The color image synthesized by the color synthesizing prism 34 is emitted to the projection lens 35. In the LCD projector of the present preferred embodiment, an opening 11 (see FIG. 7) is defined between the color synthesizing prism 34 and the projection lens 35. A color image emitted from the color synthesizing prism 34 passes through the opening 11 to enter the projection lens 35. As shown in FIG. 7, the opening 11 is formed in a mounting table 24 of the shutter system 2 described later, and the mounting table 24 is fixed to the device body 1 (case body 41). So, the opening 11 is regarded as being defined in the device body 1.

The projection lens 35 is so defined as to penetrate the part 412 of the through hole 411 as shown in FIG. 1. The projection lens 35 enlarges a color image generated by the color synthesizing prism 34, and projects the enlarged color image onto a screen arranged in front of the LCD projector.

The shutter system 2 is arranged between the color synthesizing prism 34 and the projection lens 35 as shown in FIGS. 4 to 6. A color image can temporarily be intercepted by covering and exposing the opening 11. That is, by temporarily intercepting a color image emitted from the color synthesizing prism 34 toward the projection lens 35, the shutter system 2 can temporarily suspend the image projection onto the screen while causing the light source to stay on. The structure of the shutter system 2 is described in more detail below.

As shown in FIGS. 7 to 9, the shutter system 2 includes a door 21, an arm 22, a motor 23, a mounting table 24, a cover member 25, and a gear 26. The arm 22 and the motor 23 are arranged on a front surface 24a of the mounting table 24. The door 21 is arranged on a rear surface 24b of the mounting table 24. Although not shown, the mounting table 24 is fixed to the case body 41.

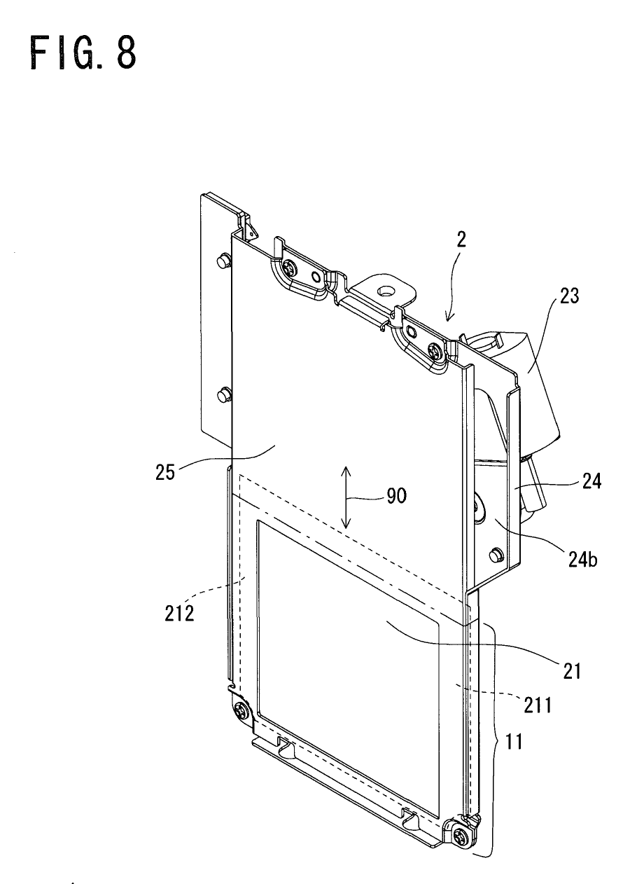

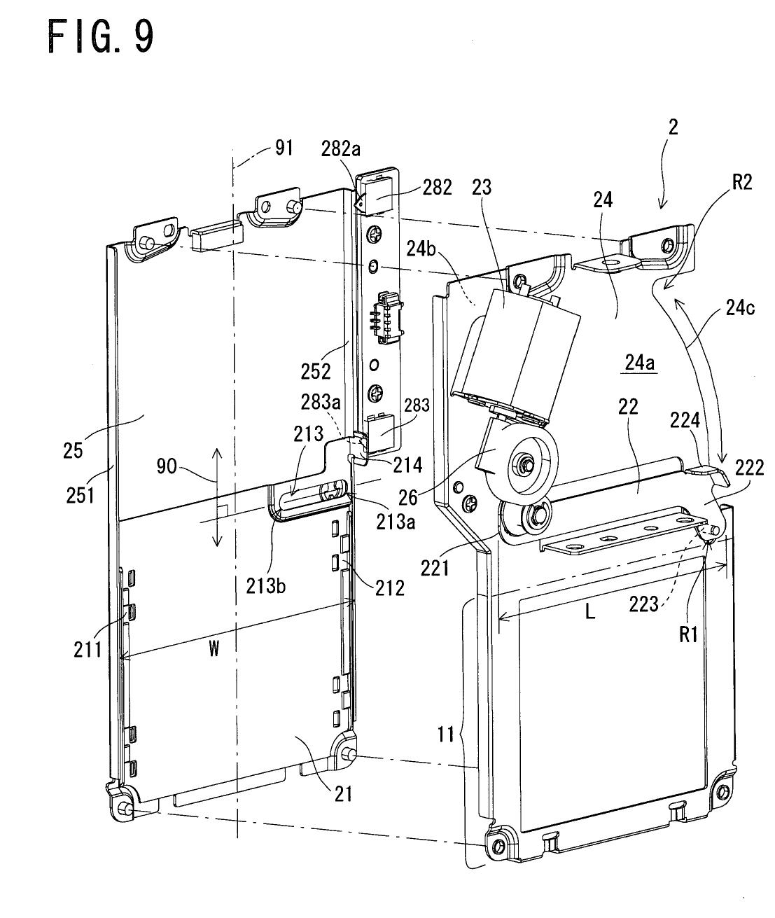

The door 21 can slide up and down along the rear surface 24b of the mounting table 24 as shown in FIGS. 8 and 9. The door 21 covers and exposes the opening 11 to temporarily intercept a color image. That is, the door 21 can move back and forth between an open position for exposing the opening 11 and a closed position for covering the opening 11. The rear surface 24b of the mounting table 24 is covered with the cover member 25 as shown in FIG. 8, and the door 21 slides in a gap between the mounting table 24 and the cover member 25.

As shown in FIG. 9, the cover member 25 is provided with guides 251 and 252 for guiding the movement of the door 21 in a sliding direction 90. Thus, the door 21 is guided by the guides 251 and 252 so that the door 21 moves straight in the sliding direction 90.

The arm 22 is pivotably supported on the front surface 24a of the mounting table 24. More specifically, a root end 221 of the arm 22 is pivotably supported on the front surface 24a of the mounting table 24 at a position near the opening 11, and closer to a side edge portion 211 of the door 21 than a center line 91 of the width of the door 21, as shown in FIGS. 7 to 9. A length L of the arm 22 is approximately the same as a width W of the door 21 as shown in FIG. 9. The center line 91 is a center line of the door 21, or of the shutter system 2.

Accordingly, the arm 22 can swing along the front surface 24a of the mounting table 24 about the root end 221 as a pivot point. Further, a front end 222 of the arm 22 can move back and forth along an orbit about the pivot point, and between a position R1 near the opening 11 and closer to a side edge portion 212 of the door 21 than the center line 91 and a position R2 near an upper edge of the front surface 24a of the mounting table 24. The arm 22 is caused to pivot about the pivot point by transmitting the rotation of the motor 23 through the gear 26 to the root end 221.

An edge 24c of the mounting table 24 arcuately extends along the orbit of the front end 222 about the pivot point (root end 221). Further, the front end 222 engages with the side edge portion 212 of the door 21 at a position outside the edge 24c of the mounting table. That is, the front end 222 of the arm 22 engages with the side edge portion 212 of the door 21 without holding the mounting table 24 therebetween.

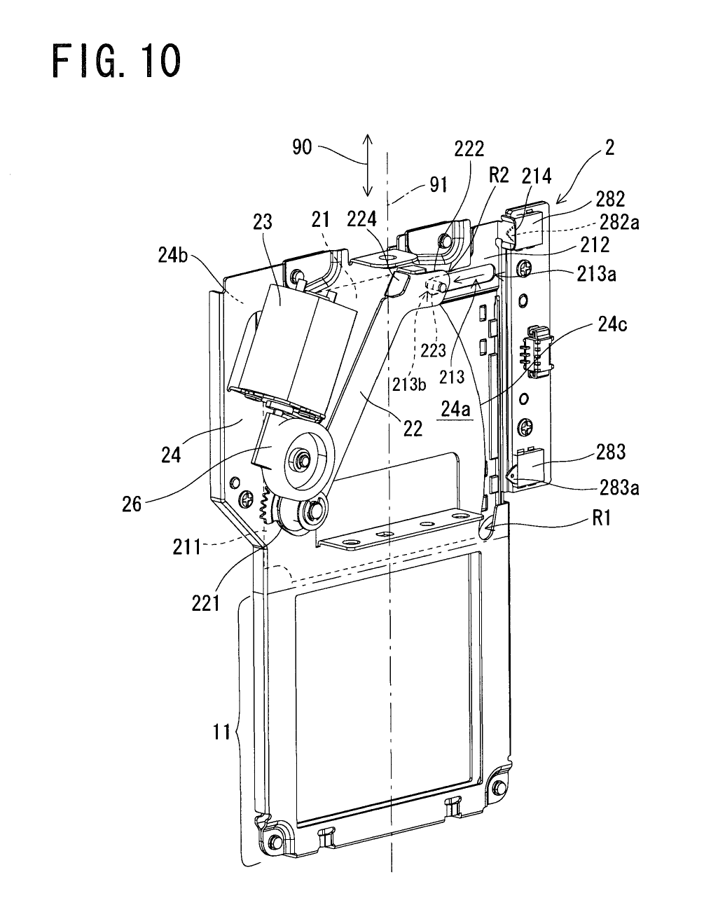

More specifically, as shown in FIG. 7 (or FIG. 10), the front end 222 of the arm 22 and the side edge portion 212 of the door 21 are provided with an engagement mechanism including a projection 223 and an engagement hole 213 into which the projection 223 is slidably fitted. In more detail, the projection 223 is provided to the front end 222 of the arm 22, and the engagement hole 213 is provided to the side edge portion 212 of the door 21. The engagement hole 213 extends in a direction perpendicular to the sliding direction 90 of the door 21.

According to the above-described structures of the door 21 and the arm 22, by causing the arm 22 to pivot about the pivot point to move the front end 22 to the position R1, the door 21 slides toward the opening 11 as shown in FIG. 7 (or FIG. 9). At this time, of ends 213a and 213b of the engagement hole 213, the projection 223 slides toward the end 213a farther from the center line 91 as shown in FIG. 7. Thus, the door 21 is guided by the guides 251 and 252 so that the door 21 can move straight in the sliding direction 90. As a result, the opening 11 is covered with the door 21.

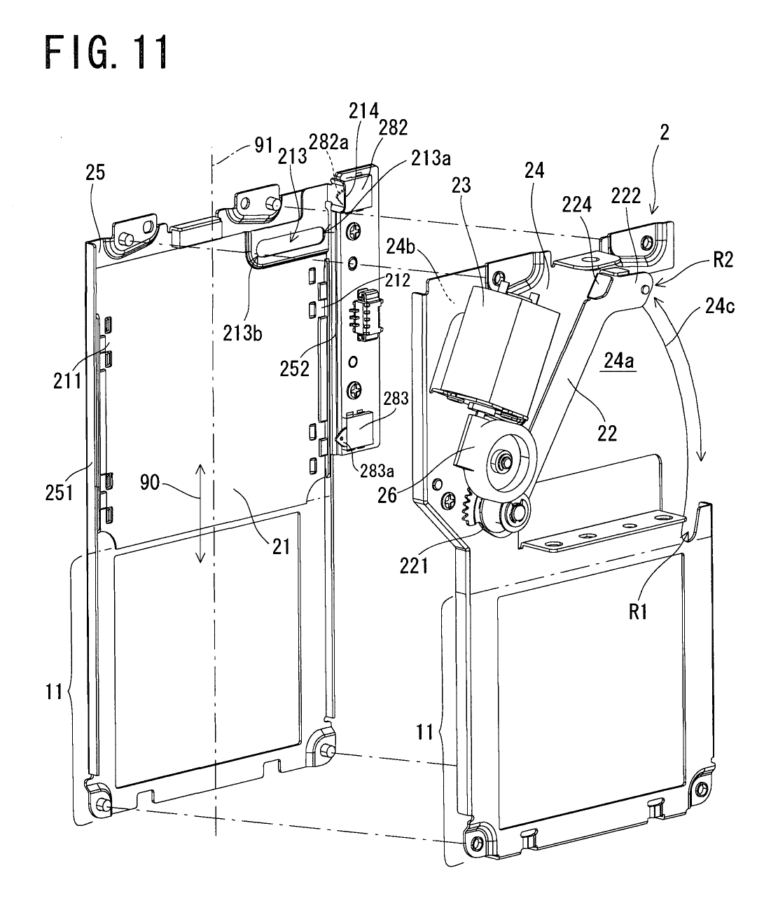

In contrast, by causing the arm 22 to pivot about the pivot point to move the front end 222 to the position R2, the door 21 slides to reach a position overlapping the rear surface 24b of the mounting table 24, in other words, the position overlapping the arm 22 as shown in FIG. 10 (or FIG. 11). At this time, the projection 223 slides toward the end 213b closer to the center line 91 as shown in FIG. 10. Thus, the door 21 is guided by the guides 251 and 252 so that the door 21 can move straight in the sliding direction 90. As a result, the opening 11 is exposed.

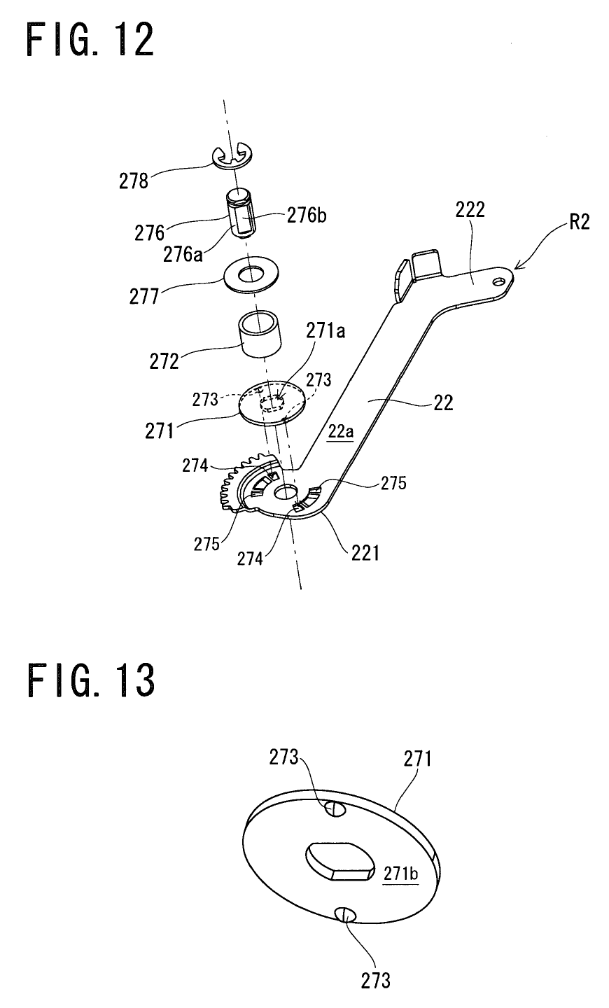

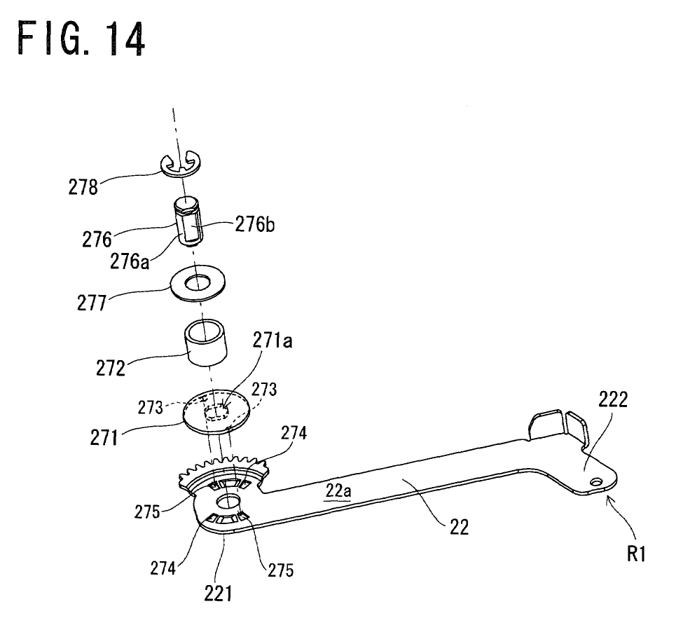

A loosely fixing mechanism is linked to the arm 22. The loosely fixing mechanism loosely fixes the arm 22 when the front end 222 is placed at the position R2, namely when the door 21 is placed at the open position (see FIG. 10) as shown in FIG. 12, while loosely fixing the arm 22 when the front end 222 is placed at the position R1, namely when the door 21 is placed at the closed position (see FIG. 7) as shown in FIG. 14.

As shown in FIGS. 12 and 14, the loosely fixing mechanism is constituted by a click plate 271, a spring member 272, projections 273, and depressions 274 and 275 in pairs. The click plate 271 can move in the axial direction of a support shaft 276 for supporting the arm 22, while being prevented from rotating about the axis of the support shaft 276. More specifically, a through hole 271a through which the support shaft 276 passes is defined in the click plate 271. In order to prevent the rotation of the click plate 271 about the axis of the support shaft 276, a side surface 276a of the support shaft 276 has a planar area 276b, and the through hole 271a of the click plate 271 is so defined as to fit the side surface 276a about the axis of the support shaft 276.

The spring member 272 is a coil compression spring. While being held in a compressed state between the click plate 271 and a spacer 277, the spring member 272 holds the support shaft 276 fitted thereinto. In order to keep the spring member 272 in the compressed state, a retention member 278 is attached to the support shaft 276 at a position opposite to the spring member 272 with respect to the spacer 277. As a result, the click plate 271 is biased by the spring member 272 toward the arm 22.

The projections 273 project from a surface 271b of the click plate 271 on the side of the arm 22 as shown in FIG. 13. The depressions 274 and 275 in pairs are defined in a surface 22a of the arm 22 on the side of the click plate 271. More specifically, of the depressions 274 and 275 in pairs, the depressions 274 are arranged at positions where the projections 273 are loosely fixed when the door 21 is placed at the open position as shown in FIG. 12. The depressions 275 are arranged at positions where the projections 273 are loosely fixed when the door 21 is placed at the closed position as shown in FIG. 14.

As described above, the loosely fixing mechanism is linked to the arm 22. So, the projections 273 of the loosely fixing mechanism are loosely fixed to the depressions 275 when the door 21 is placed at the closed position for covering the opening 11 (FIG. 14), namely the arm 22 is loosely fixed by the loosely fixing mechanism when the door 21 is placed at the closed position. Thus, the door 21 tries to stay at the closed position even when external force is applied in a direction in which the door 21 is opened. Further, the projections 273 of the loosely fixing mechanism are loosely fixed to the depressions 274 when the door 21 is placed at the open position for exposing the opening 11 (FIG. 12), namely the arm 22 is loosely fixed by the loosely fixing mechanism when the door 21 is placed at the open position. Thus, the door 21 tries to stay at the open position even when external force is applied in a direction in which the door 21 is closed.

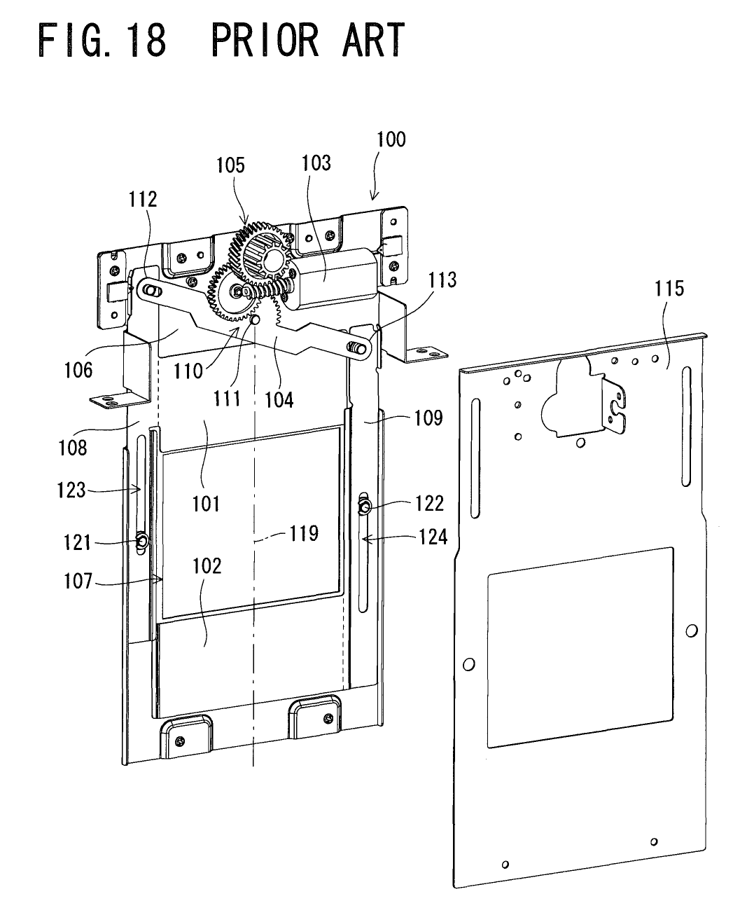

According to the LCD projector described above, the distance from the root end 221 (pivot point) to the front end 222 (point of effort) of the arm 22, namely the length L of the arm 22 is greater the half the width W of the shutter system 2. So, compared to the conventionally used shutter system (FIG. 18) in which the length of the arm from the pivot point to either end is half the width of the shutter system 100, a ratio of the length of the arm to the width of the shutter system can be higher. Thus, provided that the same width of the shutter system is given, a stroke of the front end 222 of the arm 22 is longer than in the conventionally used shutter system with the same angle of rotation.

Thus, the door 21 moves a longer distance in the sliding direction 90 than in the conventionally used shutter system. So, like the LCD projector of the present preferred embodiment, the opening 11 can be covered and exposed by the single door 21. The shutter system 2 including the single door 21 can be applied for example to an LCD projector in which the door 21 may be held on only one side of the opening 11. Further, the simple structure of the shutter system 2 allows the door 21 to be smoothly opened and closed.

Still further, the arm 22 is arranged on the front surface 24a, and the door 21 is arranged on the rear surface 24b of the mounting table 24. Thus, the door 21 and the arm 22 do not interfere with each other for opening and closing the door 21, by which the shutter system 2 is insusceptible to damage. The arm 22 and the door 21 are so arranged as to overlap each other when the door 21 is placed at an open position for exposing the opening 11 (see FIGS. 10 and 11). This reduces the size of the shutter system 2 to thereby realize downsizing of the LCD projector.

Further, the door 21 and the arm 22 engage with each other by the engagement mechanism (including the projection 223 and the engagement hole 213). Thus, the door 21 can stably move straight in the sliding direction 90.

In the LCD projector described above, the distance from the root end 221 (pivot point) to the front end 222 (point of effort) of the arm 22 is long. So, when the arm 22 is caused to pivot by hand on the occurrence of breakage of the motor 23, torque required for the pivotal movement of the arm 22 can be generated by a small control force. As a result, the door 21 can easily be opened and closed by hand.

From this point of view, the LCD projector of the present preferred embodiment has a tab 224 provided at the front end 222 of the arm 22 as shown in FIG. 7. Thus, the arm 22 can easily be operated by hand, and an operator can recognize a position for holding the arm 22 when the arm 22 is operated by hand. The cover 42 is detached from the case body 41 as shown in FIG. 3 when the arm 22 is caused to pivot by hand.

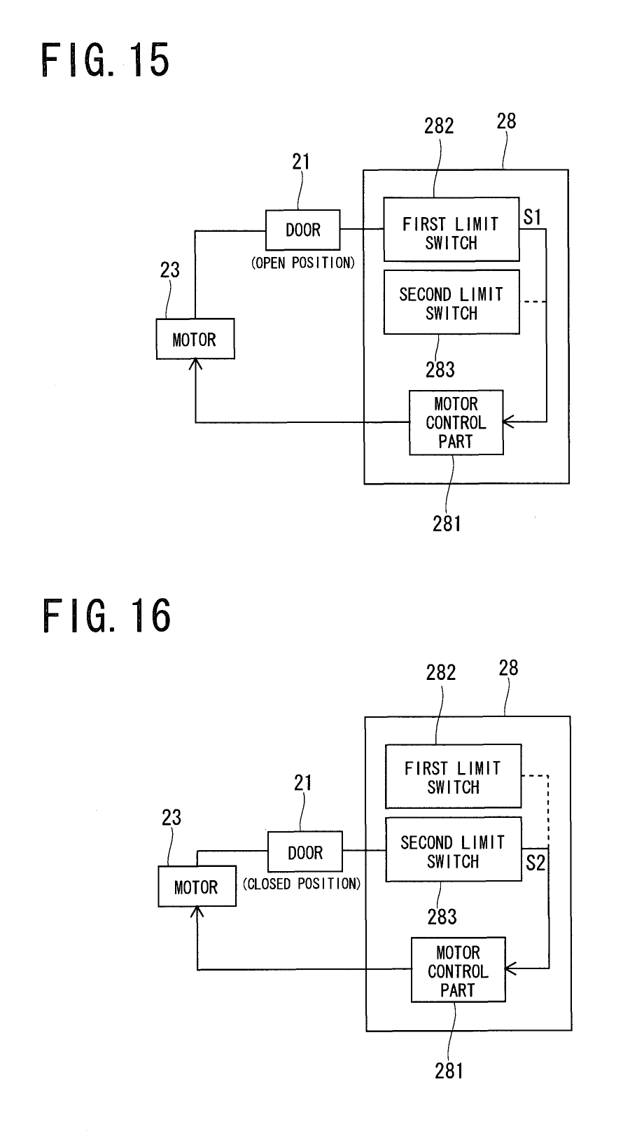

The shutter system 2 described above further includes a controller 28 for controlling the operation of the motor 23 as shown in FIGS. 15 and 16 (block diagrams). The controller 28 includes a motor control part 281 for switching the function of the motor 23 between an electric motor and an electric generator. More specifically, the motor control part 281 of the motor 28 causes the motor 23 to function as an electric motor in the process of opening or closing the door 21.

In contrast, the motor control part 281 of the controller 28 causes the motor 23 to function as an electric generator when the door 21 is loosely fixed at the open or closed position. As a result, the motor 23 prevents the movement of the door 21 from the state in which the door 21 is loosely fixed at the open or closed position (brake-mode control). Thus, the door 21 does not easily deviate from the open or closed position contrary to an operator's intention.

Even when the door 21 is held at the open or closed position by the loosely fixing mechanism and the brake-mode control described above, the door 21 may be released from its loosely fixed state in opposition to the fixing force of the loosely fixing mechanism and the force of the motor 23 to prevent the movement of the door 21 when external force is applied. As a result, the door 21 may deviate from the open or closed position. The shutter system 2 described above includes the single door 21. So, the door 21 has a weight greater than that of one of the doors moving in opposite directions in the conventionally used shutter system. Further, the arm 22 has a length greater than that of the arm in the conventionally used shutter system. Still further, the door 21 engages with only one end (front end 222) of the arm 22. So, especially in the above-described shutter system 2, high torque is likely to be generated at the front end 222 of the arm 22 by the application of external force, by which the door 21 may deviate from the open or closed position.

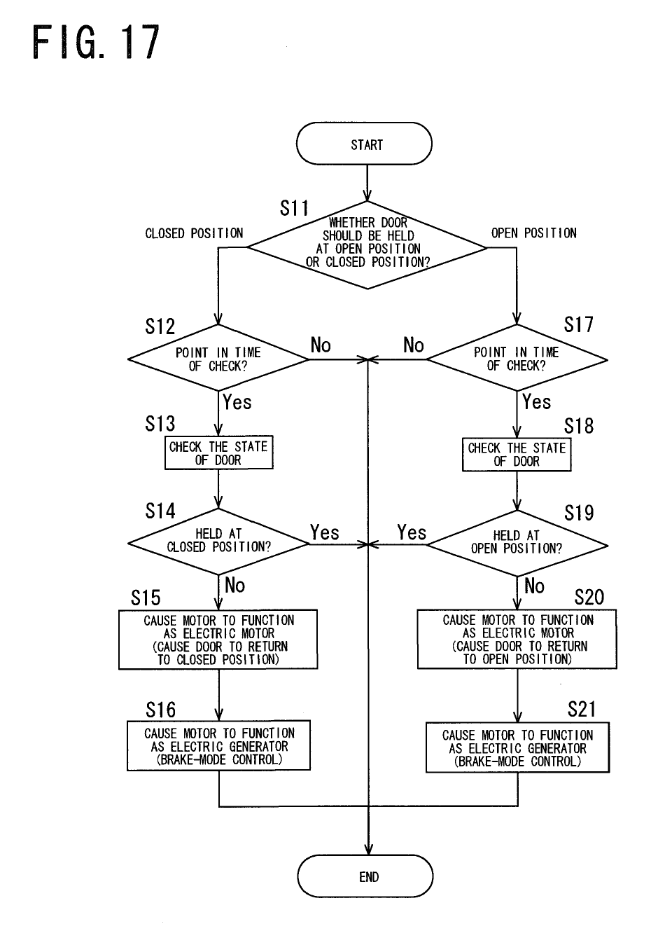

For this reason, the controller 28 includes a detection part with a first limit switch 282 and a second limit switch 283 in addition to the motor control part 281 as shown in FIGS. 15 and 16, and controls the shutter system 2 in accordance with the flow diagram shown in FIG. 17.

As shown in FIG. 9, the first and second limit switches 282 and 283 are respectively arranged one above the other along the guide 252 of the cover member 25. The first and second limit switches 282 and 283 respectively have switching buttons 282a and 283a for switching the first and second limit switches 282 and 283 between ON and OFF. The switching buttons 282a and 283a face toward a path along which the door 21 slides. The door 21 has a pressure part 214 for pressing the switching buttons 282a and 283a that is provided to the side edge portion 212 on the same side as the guide 252.

When the door 21 reaches the open position, the pressure part 214 reaches a position facing the first limit switch 282, and presses the switching button 282a as shown in FIG. 10. This switches the first limit switch 282 from OFF to ON, by which an ON signal S1 indicating that the first limit switch 282 is ON is output from the first limit switch 282 as shown in FIG. 15.

In contrast, when the door 21 reaches the closed position, the pressure part 214 reaches a position facing the second limit switch 283, and presses the switching button 283a as shown in FIG. 7. This switches the second limit switch 283 from OFF to ON, by which an ON signal S2 indicating that the second limit switch 283 is ON is output from the second limit switch 283 as shown in FIG. 16.

When the door 21 should be held at the open or closed position, the above-described detection part detects the switching of the first or second limit switch 282 or 283 from ON to OFF, thereby detecting the deviation of the door 21 from the open or closed position. More specifically, the detection part or the controller 28 detects the presence or absence of the ON signal S1 or S2, thereby detecting the deviation of the door 21 from the open or closed position.

The controller 28 controls the shutter system 2 following steps S11 to S21 shown in FIG. 17. When the control of the shutter system 2 is started, the controller 28 first determines in step S11 whether the door 21 should be placed at the open position or at the closed position. If the controller 28 judges in step S11 that the door 21 should be placed at the closed position, the control flow goes to step S12. In contrast, if the controller 28 judges in step S11 that the door 21 should be placed at the open position, the control flow goes to step S17.

In step S12, the controller 28 determines whether or not the state of the door 21 should be checked. More specifically, an interval (cycle) between two consecutive points in time at which the state of the door 21 should be checked is set in advance. Then, the controller 28 determines in step S12 whether or not a point in time at which the control flow just moved to step S12 from step S11, or a point in time immediately after the control flow moved to step S12 has reached a point in time of the check. If the controller 28 judges in step S12 that the state of the door 21 should not be checked, the control flow ends here. The control flow is thereafter restarted and then moves to step S11. In contrast, if the controller 28 judges in step S12 that the state of the door 21 should be checked, the control flow moves to step S13.

In step S13, the detection part checks the state of the door 21, namely, the detection part determines whether or not the door 21 is held at the closed position. More specifically, the detection part determines whether or not the second limit switch 283 is held ON (see FIG. 16), namely whether or not the ON signal S2 is being output from the second limit switch 283. If the door 21 is judged to be held at the closed position in step S14 as a result of the determination, the control flow ends here. The control flow is thereafter restarted and then moves to step S11. In contrast, if the door 21 is judged not to be at the closed position, namely if the door 21 is judged to deviate from the closed position in step S14 as a result of the determination, the control flow moves to step S15.

In step S15, the motor control part 281 causes the motor 23 to function as an electric motor so that the door 21 returns to its original position (closed position). In view of the fact that the motor control part 281 causes the door 21 to return to its original position by controlling the motor 23 in step S15, the motor control part 281 is regarded as a return part.

After the door 21 returns to its original position (closed position) in step S15, the motor control part 281 causes the motor 23 to function as an electric generator in step S16. Thus, the movement of the door 21 loosely fixed at the closed position is prevented by the motor 23 (brake-mode control). The control flow ends after step S16. The control flow is thereafter restarted and then moves to step S11.

In step S17, the controller 28 determines whether or not the state of the door 21 should be checked. More specifically, the controller 28 determines in step S17 whether or not a point in time at which the control flow just moved to step S17 from step S11, or a point in time immediately after the control flow moved to step S17 has reached a point in time of the check. If the controller 28 judges in step S17 that the state of the door 21 should not be checked, the control flow ends here. The control flow is thereafter restarted and then moves to step S11. In contrast, if the controller 28 judges in step S17 that the state of the door 21 should be checked, the control flow moves to step S18.

In step S18, the detection part checks the state of the door 21, namely, the detection part determines whether or not the door 21 is held at the open position. More specifically, the detection part determines whether or not the first limit switch 282 is held ON (see FIG. 15), namely whether or not the ON signal S1 is being output from the first limit switch 282. If the door 21 is judged to be held at the open position in step S19 as a result of the determination, the control flow ends here. The control flow is thereafter restarted and then moves to step S11. In contrast, if the door 21 is judged not to be at the open position, namely if the door 21 is judged to deviate from the open position in step S19 as a result of the determination, the control flow moves to step S20.

In step S20, the motor control part 281 causes the motor 23 to function as an electric motor so that the door 21 returns to its original position (open position). After the door 21 returns to its original position (open position) in step S20, the motor control part 281 causes the motor 23 to function as an electric generator in step S21. Thus, the movement of the door 21 loosely fixed at the open position is prevented by the motor 23 (brake-mode control). The control flow ends after step S21. The control flow is thereafter restarted and then moves to step S11.

According to the control of the shutter system 2 described above, even when external force is applied to release the door 21 from its loosely fixed state in opposition to the fixing force of the loosely fixing mechanism and the force of the motor 23 to prevent the movement of the door 21 so that the door 21 deviates from the open or closed position, the door 21 returns to its original position and is held at the open or closed position again.

In the LCD projector described above, the arm 22 is so arranged as to overlap the door 21 placed at the open position for exposing the opening 11. Alternatively, the arm 22 may be so arranged as to overlap the door 21 placed at the closed position for covering the opening 11. More specifically, the opening 11 is defined on the upper side of the holding table 24 in the above-described shutter system 2. This structure also achieves the same effect as obtained by the above-described LCD projector.

In the LCD projector described above, the projection 223 constituting the engagement mechanism is provided to the front end 222 of the arm 22, and the engagement hole 213 is provided to the side edge portion 212 of the door 21. Alternatively, the projection 223 may be provided to the side edge portion 212 of the door 21, and the engagement hole 213 may be provided to the front end 222 of the arm 22.

In the LCD projector described above, the engagement hole 213 extends in a direction perpendicular to the sliding direction 90. The engagement hole 213 may alternatively extend in a direction oblique to the sliding direction 90.

The engagement mechanism of this structure also allows the door 21 to stably move straight in the sliding direction 90.

In the LCD projector described above, the projections 273 are provided to the click plate 271, and the depressions 274 and 275 in pairs are defined in the arm 22. Alternatively, the projections 273 may be provided to the arm 22, and the depressions 274 and 275 in pairs may be defined in the click plate 271.

Like the LCD projection described above, the LCD projector of this structure also allows the loosely fixing mechanism to loosely fix the arm 22 when the door 21 is placed at the open and closed positions.

In the LCD projector described above, the controller 28 including the detection part (the first and second limit switches 282 and 283) and the motor control part 281 controls the shutter system 2. However, this is not the only structure of the controller 28. The controller 28 may employ an alternative structure as long as it realizes the same control as that of the above-described shutter system 2.

The structure of each part of the present invention is not limited to that shown in the preferred embodiment described above. Various modifications may be devised within the technical scope defined in claims. Further, the present invention may be implemented not only in an LCD projector, but also in an electronic device with an opening/closing door of various types including a device body in which an opening is defined, and a shutter system capable of covering and exposing the opening.

1. An electronic device with an opening/closing door comprising a device body in which an opening is defined, a shutter system capable of covering and exposing the opening, and a loosely fixing mechanism,
the shutter system including a door capable of moving back and forth between a closed position for covering said opening and an open position for exposing said opening, an arm swingably supported by said device body and having a front end engaging with said door, a motor for opening and closing said door by driving said arm, and a controller for controlling the operation of the motor, the controller being capable of switching the function of said motor between an electric motor and an electric generator,
said loosely fixing mechanism being linked to the arm of said shutter system, and loosely fixing the arm when said door is placed at the open position, while loosely fixing the arm when said door is placed at the closed position,
said controller causing said motor to function as an electric motor in the process of opening and closing said door, while causing said motor to function as an electric generator when said door is loosely fixed at the open position or at the closed position.

2. The electronic device with an opening/closing door according to claim 1, wherein said loosely fixing mechanism includes a part capable of moving in the axial direction of a support shaft of said arm while being prevented from rotating about the axis of the support shaft, a spring member for biasing said part toward the arm, a projection projecting from said part or said arm, and depressions in a pair defined in said part or said arm to which the projection is not provided, one of said depressions in a pair loosely fixing the projection when said door is placed at said open position, the other one of said depressions in a pair loosely fixing the projection when said door is placed at said closed position.

3. The electronic device with an opening/closing door according to claim 1, wherein said controller includes:
a detection part configured to detect the deviation of said door from said open position or from said closed position when said door should be held at said open position or at said closed position; and
a return part configured to cause said door to return to its original position by causing said motor to function as an electric motor when said detection part detects deviation.

4. The electronic device with an opening/closing door according to claim 3, wherein said detection part includes a first limit switch and a second limit switch, the first limit switch being switched from OFF to ON when said door reaches said open position, said second limit switch being switched from OFF to ON when said door reaches said closed position, the detection part detecting the deviation of said door from said open position or from said closed position by detecting the switching of said first limit switch or said second limit switch from ON to OFF when said door should be held at said open position or at said closed position.

5. The electronic device with an opening/closing door according to claim 1, wherein said shutter system further includes a mounting table having a front surface and a rear surface, said arm and said motor being arranged on the front surface, said door being arranged on the rear surface, said door being capable of sliding along the rear surface of the mounting table, said arm being so arranged as to overlap said door placed at said open position or at said closed position, said arm having a root end and the front end, the root end being pivotably supported on the front surface of said mounting table at a position closer to one side edge portion of said door than a center line of the width of the door, the front end engaging with the other side edge portion of said door without holding said mounting table therebetween, said motor causing said arm to swing about said root end as a pivot point, thereby causing said door to slide along the rear surface of the mounting table.
